(19) United States
(12) Patent Application Publication
(10) Pub. No.: US 2008/0240057 A1
(43) Pub. Date: Oct. 2, 2008

(54) Accessing hardware initialization data of WLAN module using die identifier

(75) Inventor: Michael Halleck, Sunnyvale, CA (US)

Correspondence Address: TEXAS INSTRUMENTS INCORPORATED, P O BOX 655474, M/S 3999, DALLAS, TX, 75265, US

(73) Assignee: Texas Instruments Incorporated

(21) Appl. No.: 11/731,720

(22) Filed: Mar. 29, 2007

(51) Int. Cl. H04Q 7/24

(52) U.S. Cl. 370/338

(57) ABSTRACT

A method, system and apparatus of accessing hardware initialization data of WLAN module using die identifier are disclosed. In one embodiment, a method includes accessing a die identification data of a WLAN module when the WLAN module is integrated to a device having a non-volatile memory, and writing initialization data corresponding to the die identification data to the non-volatile memory. The method may further include storing the initialization data to a database file during a manufacturing process of the WLAN module. The method may include comprising detecting a presence of the initialization data through accessing the non-volatile memory. In addition, the method may include automatically fetching the initialization data of the database file using a trivial file transfer protocol (TFTP) when the detecting the presence of the initialization data fails.

### FIELD OF TECHNOLOGY

This disclosure relates generally to the technical fields of telecommunication hardware and/or software, and in one embodiment, to a method, system and apparatus of accessing hardware initialization data of WLAN module using die identifier.

### BACKGROUND

A WLAN (Wireless Local Area Network) is a network which may utilize different technologies (e.g., spread-spectrum technologies) based on electromagnetic waves (e.g., radio waves) to enable communication between devices in a limited area without using wires. The WLAN may allow users to access network resources from almost any convenient location within their primary networking environment (e.g., home, office, etc.) using WLAN devices.

Generally, a WLAN device may come with a physical EEPROM (e.g., an IC) located on a WLAN hardware board. The EEPROM (electrically erasable programmable read only memory) may be a computer memory chip which may available in sizes ranging from few bytes to 128 kilobytes. The EEPROM embedded in the WLAN hardware may hold manufacturing data (e.g., calibration data, vendor specific information, etc.) associated with WLAN device, programmed during manufacturing stage. The EEPROM having the manufacturing data associated with the WLAN device may retain the manufacturing data when the power is switched off. The manufacturing data stored in the EEPROM of the WLAN device may be a set of parameters used by the WLAN device during the hardware initialization stage. In addition, some of the parameters associated with WLAN device may be unique to each device.

The integration of EEPROM on the WLAN hardware may be costly and may occupy more space. Thus, the need for a non-volatile memory to capture the manufacturing data of the WLAN device in a simple, foolproof and cost efficient manner may be keenly felt by the manufacturers, system integrators and/or users.

### SUMMARY OF THE DISCLOSURE

A method, system and apparatus of accessing hardware initialization data of WLAN module using die identifier are disclosed. In one aspect, a method includes accessing a die identification data of a wireless local area network (WLAN) module (e.g., manufactured separately from the device) when the WLAN module is integrated to a device having a non-volatile memory (e.g., of a non-volatile storage device embedded in the device), and writing initialization data corresponding to the die identification data to the non-volatile memory.

In addition, the method may include storing the initialization data to a database file (e.g., the database file may be stored to a server and/or a portable storage device including a diskette, a compact disc, a hard disk, and/or a flash drive) during a manufacturing process of the WLAN module. The initialization data may include at least vendor specific data (e.g., a platform type, a radio type, a media access control address, a boot loader sequence, a register setting, and/or other data) and calibration data which render an optimal performance of the WLAN module while meeting a specification of the WLAN module. The die identification data embedded in a die identification register of the WLAN module is a unique value assigned to a chipset of the WLAN module.

Furthermore, the method may include detecting a presence of the initialization data through accessing the non-volatile memory. Also, the method may include automatically fetching the initialization data of the database file using a trivial file transfer protocol (TFTP) when the detecting the presence of the initialization data fails. The method may further include loading the initialization data to the non-volatile memory of the device using the TFTP when the initialization data corresponds to the die identification data.

In another aspect, a system includes a server to store initialization data of a WLAN module, and a loading module of a data processing system to duplicate the initialization data to non-volatile memory of a device based on a die identification data of the WLAN module when the WLAN module is integrated to the device. The system may further include a testing device coupled to the WLAN module to obtain calibration data of the initialization data associated with the WLAN module during a manufacturing process of the WLAN module.

In addition, the system may include a die identification register (e.g., 64 bit in size) of the WLAN module to store the die identification data of the WLAN module. Also, the initialization data may include a header which is identical to the die identification data of the WLAN module. The system may further include a non-volatile storage device associated with the device to store the initialization data when the die identification data of the WLAN module in the device matches with the header of the initialization data. Additionally, the system may include delivering the initialization data using a portable storage device (e.g., a floppy disk, a compact disc, an optical disk, a hard disk, a flash drive, and/or other portable device).

In yet another aspect, an apparatus includes a loading module to write initialization data to a non-volatile memory of a device having a WLAN module when a die identification data of the WLAN module corresponds to the initialization data. The apparatus may further include a match module of the loading module to compare a header of the initialization data with the die identification data of the WLAN module when the WLAN module is integrated to the device. Moreover, the loading module may operate as a part of a boot sequence of the device during a manufacturing process of the device.

The methods, systems, and apparatuses disclosed herein may be implemented in any means for achieving various aspects, and may be executed in a form of a machine-readable medium embodying a set of instructions that, when executed by a machine, cause the machine to perform any of the operations disclosed herein. Other features will be apparent from the accompanying drawings and from the detailed description that follows.

### BRIEF DESCRIPTION OF THE DRAWINGS

Example embodiments are illustrated by way of example and not limitation in the figures of the accompanying drawings, in which like references indicate similar elements and in which:

FIG. 1 is a schematic representation of storing initialization data to a database file during manufacturing process of a wireless local area network (WLAN) module, according to one embodiment.

FIG. 2 is a representation of different types of the initialization data of FIG. 1, according to one embodiment.

FIG. 3 is a schematic representation of duplicating the initialization data to a non-volatile memory of device(s) using a trivial file transfer protocol (TFTP), according to one embodiment.

FIG. 4 is a block diagram of a loading module interacting the device of FIG. 3, according to one embodiment.

FIG. 5 is a process flow of accessing the hardware initialization data of the WLAN module, according to one embodiment.

FIG. 6 is a diagrammatic system view of the data processing system in which any of the embodiments disclosed herein may be performed, according to one embodiment.

Other features of the present embodiments will be apparent from the accompanying drawings and from the detailed description that follows.

### DETAILED DESCRIPTION

A method, system and apparatus of accessing hardware initialization data (e.g., or manufacturing data) of WLAN module using die identifier are disclosed. In the following description, for the purposes of explanation, numerous specific details are set forth in order to provide a thorough understanding of the various embodiments. It will be evident, however to one skilled in the art, that the various embodiments may be practiced without these specific details.

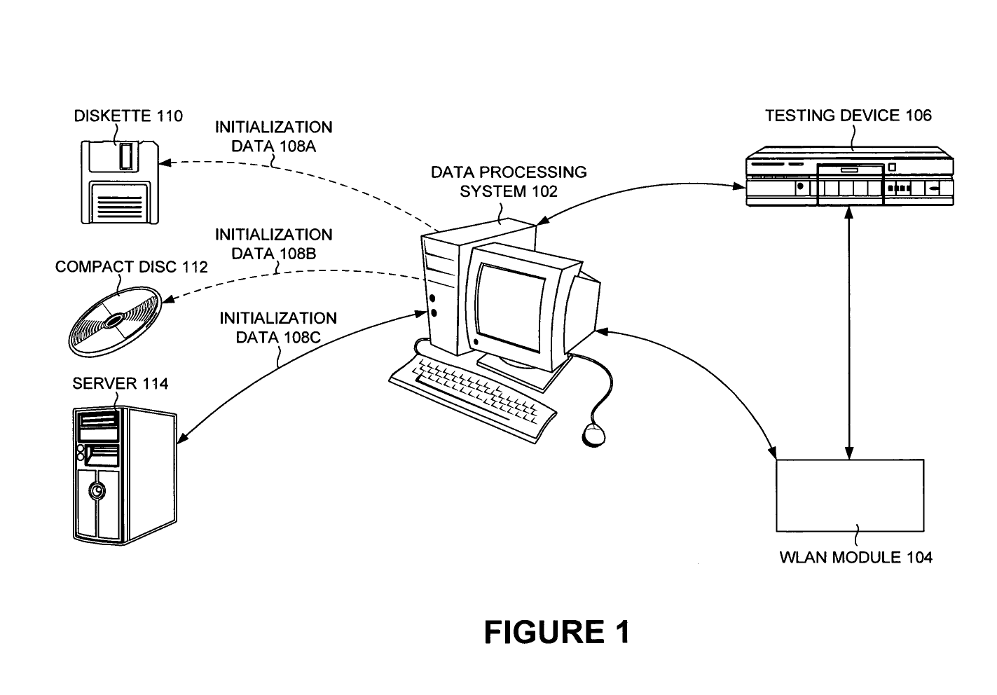

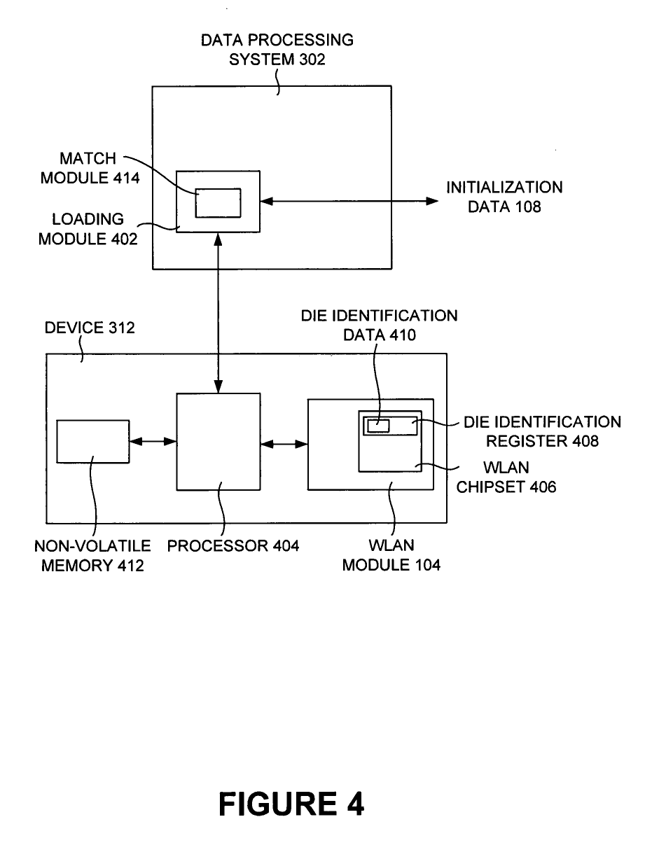

In one embodiment, a method includes accessing a die identification data (e.g., the die identification data 410 of FIG. 4) of a wireless local area network (WLAN) module (e.g., the WLAN module 104 of FIG. 1-4) when the WLAN module is integrated to a device (e.g., manufactured separately from the WLAN module) having a non-volatile memory (e.g., the non-volatile memory 412 of FIG. 4), and writing initialization data (e.g., the initialization data 108A-C of FIG. 1-4) corresponding to the die identification data to the non-volatile memory.

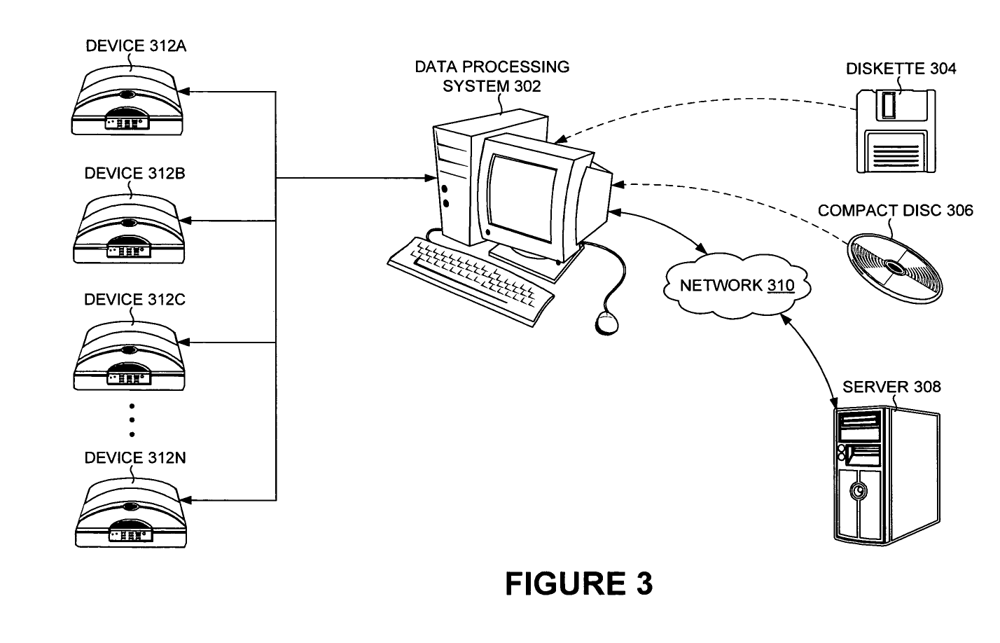

In another embodiment, a system includes a server (e.g., the server 114 of FIG. 1) to store initialization data of a WLAN module (e.g., the WLAN module 104 of FIG. 1-4), and a loading module (e.g., the loading module 402 of FIG. 4) of a data processing system (e.g., the data processing system 302 of FIG. 3) to duplicate the initialization data to non-volatile memory of a device (e.g., the device 312 of FIG. 4) based on a die identification data of the WLAN module when the WLAN module is integrated to the device.

In yet another embodiment, an apparatus includes a loading module to write initialization data to a non-volatile memory of a device having a WLAN module when a die identification data of the WLAN module corresponds to the initialization data.

FIG. 1 is a schematic representation of storing initialization data 108A-C to a database file during a manufacturing process of a WLAN module 104, according to one embodiment. Particularly, FIG. 1 illustrates the data processing system 102, the WLAN module 104, a testing device 106, the initialization data 108A-C, a diskette 110, a compact disc 112 and a server 114, according to one embodiment.

The data processing system 102 may be a device (e.g., a computer, a compiler, etc.) that captures and processes the initialization data 108A-C (e.g., vendor specific data and calibration data) of the WLAN module 104 to store the initialization data into the database file (e.g., stored in the server 114 and/or a portable storage device like the diskette, the compact disc, a hard disk, a flash drive, etc.) during the manufacturing process of the WLAN module 104. The WLAN module 104 may consist of a die identification register in which the die identification data (e.g., a unique value assigned to a chipset of the WLAN module) is embedded during the manufacturing process of the WLAN module. The testing device 106 may be a RF tester coupled to the WLAN module 104 to obtain the initialization data 108A-C associated with the WLAN module 104 during the manufacturing process of the WLAN module 104.

The initialization data 108A-C may include the vendor specific data and the calibration data used by the WLAN module 104 during the hardware initialization stage. The vendor specific data may include a platform type, a radio type, a MAC address, a boot loader sequence, register settings and/or other data. The diskette 110 may be a data storage device composed of a disk of thin flexible magnetic storage medium in which the database file containing the initialization data 108A-C associated with the WLAN module 104 is stored. The compact disc 112 may be an optical disc used to store the database file containing the initialization data 108A-C during the manufacturing process of the WLAN module 104. The server 114 may enable storing of the initialization data associated with the WLAN module 104 through the data processing system 102.

In the example embodiment illustrated in FIG. 1, the data processing system communicates with the WLAN module 104, the testing device 106, the diskette 110, the compact disc 112, and the server 114. The testing device 106 communicates with the WLAN module 104 during the manufacturing process to obtain the initialization data 108A-C of the WLAN module 104.

The initialization data 108A-C may be stored to the database file (e.g., stored in the server 114 and/or the portable storage device (e.g., the diskette, the compact disc, the hard disk, and/or the flash drive)) during the manufacturing process of the WLAN module 104. The server 114 may store the initialization data 108A-C of the WLAN module 104. The testing device 106 coupled to the WLAN module 104 may obtain the calibration data of the initialization data 108A-C associated with the WLAN module 104 during the manufacturing process of the WLAN module 104.

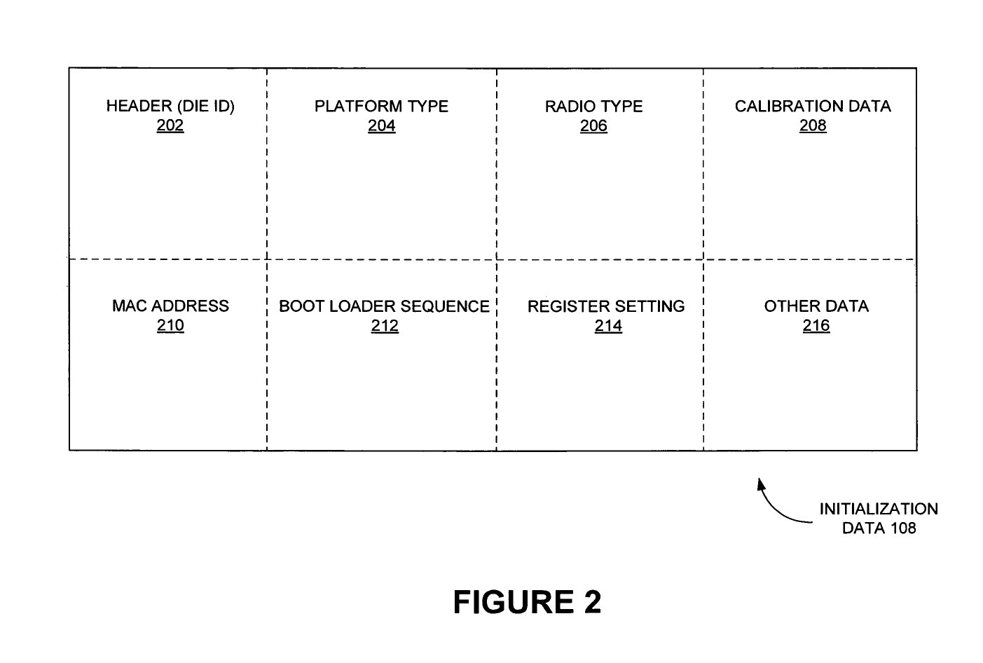

FIG. 2 is a representation of different types of the initialization data 108 of FIG. 1, according to one embodiment. Particularly, FIG. 2 illustrates a header (DIE ID) 202, a platform type 204, a radio type 206, a calibration data 208, a MAC address 210, a boot loader sequence 212, a register setting 214 and other data 216, according to one embodiment.

The header (DIE ID) 202 may be a type of the initialization data which is identical to the die identification data of the WLAN module (e.g., the WLAN module 104 of FIG. 1-4). The platform type 204 may contain information associated with architecture, an operating system and/or runtime libraries of an operating platform. The radio type 206 may contain the details of data associated with amplitude, frequency and/or phase of a wave used for wireless communication. The calibration data 208 may be radio calibration parameters generated for each WLAN module during the manufacturing process and may define a relation between an output of the WLAN module and an input applied. The MAC address 210 may be a unique identifier assigned to each WLAN module integrated in the device.

The boot loader sequence 212 may be a set of operations executed to load a software for the operating system to start when power is switched on. The register setting 214 may consist of PLL (Phase Locked Loop), resets and/or VLYNQ (serial interface) to support retrieval of the die identification data of the WLAN module. The other data 216 may be other configuration parameters associated with nature, number, and/or chief characteristics of the WLAN module.

In the example embodiment as illustrated in FIG. 2, the block displays the different types of initialization data 108 which includes the header (die ID) 202, the calibration data 208, and the other data 216. The vendor specific data includes the platform type 204, the radio type 206, the MAC address 210, the boot loader sequence 212 and the register settings 214.

The initialization data 108 may include at least the vendor specific data and the calibration data which render an optimal performance of the WLAN module (e.g., the WLAN module 104 of FIG. 1-4) while meeting a specification of the WLAN module. In addition, the initialization data 108 may include the header 202 which is identical to the die identification data of the WLAN module.

FIG. 3 is a schematic representation of duplicating the initialization data to a non-volatile memory of devices 312A-N using a trivial file transfer protocol (TFTP), according to one embodiment. Particularly, FIG. 3 illustrates a data processing system 302, a diskette 304, a compact disk 306, a server 308, a network 310 and the devices 312A-N, according to one embodiment.

The data processing system 302 may compare the header of the initialization data with the die identification data of the WLAN module integrated into the devices 312A-N and duplicate the initialization data corresponding to the die identification data to the non-volatile memory (e.g., the non-volatile memory 412 of FIG. 4) of the devices 312A-N when the WLAN module is integrated to the devices 312A-N. The diskette 304 may be a removable, portable magnetic disk which contains the database file having the initialization data (e.g., the vendor specific data, the calibration data, etc.).

The compact disc 306 may be an optical, non-magnetic disk containing the database file in which the initialization data is stored in a digital form during the manufacturing process of the WLAN module. The diskette 304 and the compact disc 306 may be used to deliver the initialization data corresponding to the die identification data embedded in the die identification register of the WLAN module to non-volatile memory of the devices 312A-N using the TFTP, when the WLAN module is integrated into the devices 312A-N. The server 308 may contain the database file having the initialization data stored during the manufacturing process of the WLAN module.

The network 310 may enable communication between the data processing system 302 and the server 308 to retrieve the initialization data from the server to the non-volatile memory of the devices 312A-N using the TFTP. The devices 312A-N may be a DSL, a cable modem, CE products (e.g., PDA, cell phone, etc.) in which the WLAN module having the die identification data is integrated. In addition, the devices 312A-N may include the non-volatile memory in which the initialization data corresponding to the die identification of the WLAN module is duplicated using the TFTP.

In the example embodiment illustrated in FIG. 3, the data processing system 302 communicates with the diskette 304, the compact disc 306, the server 308 and the devices 312A-N. The data processing system 302 communicates with the server 308 through the network 310.

In one embodiment, the initialization data corresponding to the die identification data may be retrieved from the server 308 to the data processing system 302 through the network 310 to duplicate the initialization data to the devices 312A-N. In another embodiment, the initialization data corresponding to the die identification data of the WLAN module may be loaded directly from the diskette 304 and/or the compact disc 306 to the non-volatile memory of the devices 312A-N through the data processing system 302.

The die identification data of the WLAN module (e.g., the WLAN module 104 of FIG. 1-4) may be accessed when the WLAN module is integrated to the devices 312A-N (e.g., manufactured separately from the WLAN module) having the non-volatile memory (e.g., the non-volatile memory 412 of FIG. 4). The initialization data (e.g., the initialization data 108A-C of FIG. 1-4) may be written corresponding to the die identification data to the non-volatile memory.

A presence of the initialization data may be also detected through accessing the non-volatile memory. The initialization data of the database file may be automatically fetched using the TFTP when the detecting the presence of the initialization data fails. The initialization data may be loaded (e.g., using the loading module 402 of FIG. 4) to the non-volatile memory of the device (e.g., the devices 312A-N of FIG. 3) using the TFTP when the initialization data corresponds to the die identification data. The initialization data may be delivered using a portable storage device (e.g., a floppy disk, the compact disc, an optical disk, a hard disk, a flash drive, and/or other portable devices).

FIG. 4 is an exploded view of the device 312 of FIG. 3, according to one embodiment. Particularly, FIG. 4 illustrates the WLAN module 104, the initialization data 108, the data processing system 302, the device 312, a loading module 402, a processor 404, a WLAN chipset 406, a die identification register 408, a die identification data 410, a non-volatile memory 412 and a match module 414, according to one embodiment.

The WLAN module 104 may contain the die identification register 408 in which the die identification data is embedded during the manufacturing process of WLAN module. The initialization data 108 may be a set of parameters used by the WLAN module 104 integrated to the device 312 during the hardware initialization stage. The initialization data 108 may include the vendor specific data and the calibration data which render optimal performance of the WLAN module 104 while meeting the specification of the WLAN module 104.

The data processing system 302 may duplicate the initialization data 108 corresponding to the die identification data 410 of the WLAN module 104 to the non-volatile memory 412. The devices 312A-N may be a DSL, a cable modem, CE products (e.g., PDA, cell phone, etc.) consisting of the WLAN module 104, the processor 404, and the non-volatile memory 412. The loading module 402 may duplicate the initialization data 108 corresponding to the die identification data 410 of the WLAN module 104 to the non-volatile memory 412 of the device 312, when the WLAN module 104 is integrated to the device 312. The processor 404 may enable the duplication of the initialization data to the non-volatile memory 412. In addition, the processor 404 may access the initialization data stored in the non-volatile storage memory during the hardware initialization stage of the WLAN module 104. The WLAN chipset 406 may be a group of integrated circuits having the die identification data 410 embedded in the die identification register 408.

The die identification register 408 may be a 64 bit register in which the die identification data 410 is embedded. The die identification data 410 may be a unique value assigned to the WLAN chipset 406 of the WLAN module 104 during the manufacturing process of the WLAN module 104. The non-volatile memory 412 may be read-only memory, flash memory of a non-volatile storage device embedded in the device 312 to store the initialization data of the WLAN module 104. The match module 414 may compare the header of the initialization data with the die identification data of the WLAN module 104 prior to the duplication of the initialization data to the non-volatile memory of the device 312 through the loading module 402.

In the example embodiment illustrated in FIG. 4, the data processing system 302 includes the loading module 402. The WLAN module 104 includes the WLAN chipset 406 consisting of the die identification register 408. The loading module 402 having the match module 414 communicates with the processor 404. In addition, the processor 404 interacts with the die identification register 408 of the WLAN module 104 and the non-volatile memory 412 of the device 312.

The die identification data 410 may be accessed when the WLAN module 104 is integrated to the device 312 (e.g., manufactured separately from the WLAN module 104) having the non-volatile memory 412 (e.g., of the non-volatile storage device embedded in the device 312). The initialization data 108 corresponding to the die identification data 410 may be written to the non-volatile memory 412. The presence of the initialization data 108 may be detected through accessing the non-volatile memory 412.

The loading module 402 of the data processing system 302 may duplicate the initialization data 108 to the non-volatile memory 412 of the device 312 based on the die identification data 410 of the WLAN module 104 when the WLAN module 104 is integrated to the device 312. The loading module 402 may operate as a part of a boot sequence of the device 312 during the manufacturing process of the device. In addition, the loading module 402 may write the initialization data 108 to the non-volatile memory 412 of the device 312 having the wireless local area network (WLAN) module 104 when the die identification data 410 of the WLAN module 104 corresponds to the initialization data 108.

The die identification register (e.g., 64 bit in size) of the WLAN module 104 may store the die identification data 410 of the WLAN module 104. The non-volatile storage device associated with the device 312 may store the initialization data 108 when the die identification data 410 of the WLAN module 104 in the device 312 matches with the header (e.g., the header 202 of FIG. 2) of the initialization data 108. The match module 414 of the loading module 402 may compare the header of the initialization data 108 with the die identification data of the WLAN module 104 when the WLAN module 104 is integrated to the device 312.

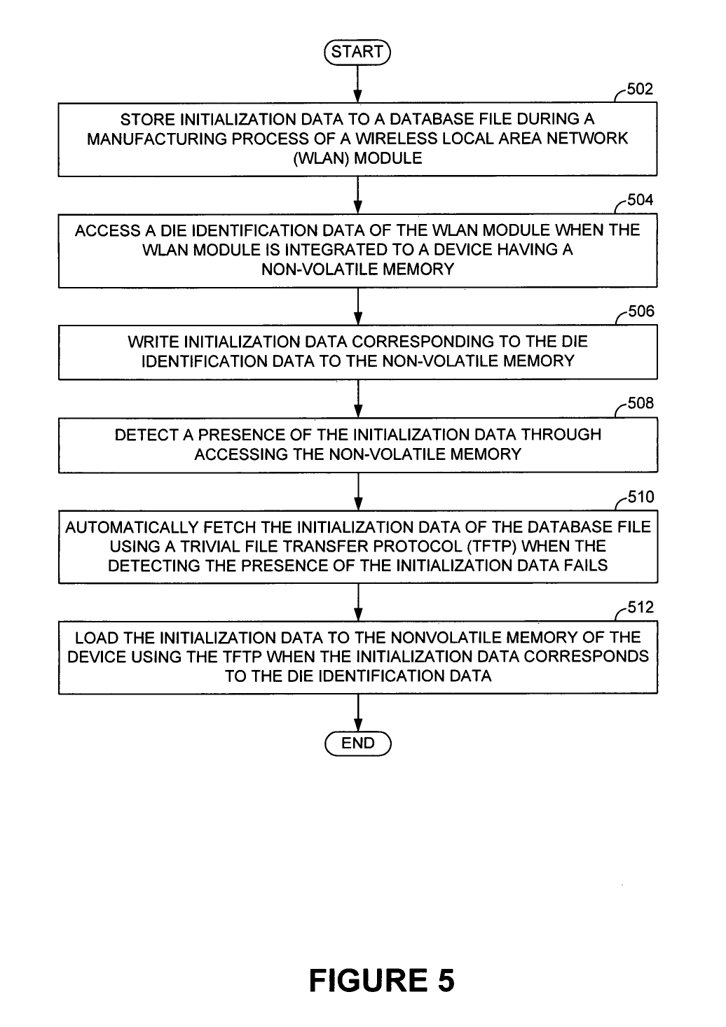

FIG. 5 is a process flow of accessing hardware initialization data of a wireless local area network (WLAN) module, according to one embodiment. In operation 502, an initialization data (e.g., the initialization data 108A-C of FIG. 1-4) may be stored to a database file during a manufacturing process of the WLAN module (e.g., the WLAN module 104 of FIG. 1). In operation 504, a die identification data (e.g., the die identification data 410 of FIG. 4) of the WLAN module may be accessed when the WLAN module is integrated to a device (e.g., the device 312 of FIG. 3) having a non-volatile memory (e.g., the non-volatile memory 412 of FIG. 4).

In operation 506, the initialization data corresponding to the die identification data may be written to the non-volatile memory. In operation 508, a presence of the initialization data may be detected through accessing the non-volatile memory. In operation 510, the initialization data of the database file may be automatically fetched using a trivial file transfer protocol (TFTP) when the detecting the presence of the initialization data fails. In operation 512, the initialization data may be loaded (e.g., through the loading module 402 of FIG. 4) to the non-volatile memory of the device using the TFTP when the initialization data corresponds to the die identification data.

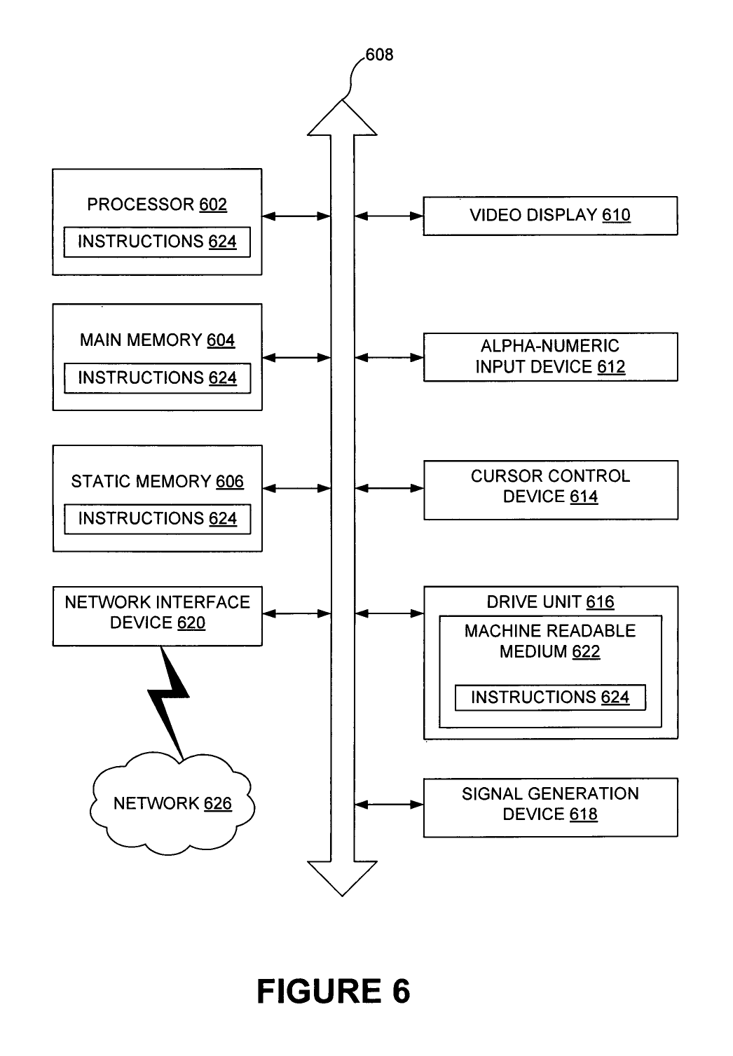

FIG. 6 is a diagrammatic system view 600 of a data processing system in which any of the embodiments disclosed herein may be performed, according to one embodiment. Particularly, the diagrammatic system view 600 of FIG. 6 illustrates a processor 602, a main memory 604, a static memory 606, a bus 608, a video display 610, an alpha-numeric input device 612, a cursor control device 614, a drive unit 616, a signal generation device 618, a network interface device 620, a machine readable medium 622, instructions 624, and a network 626, according to one embodiment.

The diagrammatic system view 600 may indicate a personal computer and/or a data processing system in which one or more operations disclosed herein are performed. The processor 602 may be microprocessor, a state machine, an application specific integrated circuit, a field programmable gate array, etc. (e.g., Intel® Pentium® processor). The main memory 604 may be a dynamic random access memory and/or a primary memory of a computer system. The static memory 606 may be a hard drive, a flash drive, and/or other memory information associated with the data processing system.

The bus 608 may be an interconnection between various circuits and/or structures of the data processing system. The video display 610 may provide graphical representation of information on the data processing system. The alpha-numeric input device 612 may be a keypad, keyboard and/or any other input device of text (e.g., a special device to aid the physically handicapped). The cursor control device 614 may be a pointing device such as a mouse.

The drive unit 616 may be a hard drive, a storage system, and/or other longer term storage subsystem. The signal generation device 618 may be a bios and/or a functional operating system of the data processing system. The network interface device 620 may be a device that may perform interface functions such as code conversion, protocol conversion and/or buffering required for communication to and from a network. The machine readable medium 622 may provide instructions on which any of the methods disclosed herein may be performed. The instructions 624 may provide source code and/or data code to the processor 602 to enable any one/or more operations disclosed herein.

Although the present embodiments have been described with reference to specific example embodiments, it will be evident that various modifications and changes may be made to these embodiments without departing from the broader spirit and scope of the various embodiments. For example, the various devices, modules, analyzers, generators, etc. described herein may be enabled and operated using hardware circuitry (e.g., CMOS based logic circuitry), firmware, software and/or any combination of hardware, firmware, and/or software (e.g., embodied in a machine readable medium).

For example, the various electrical structure and methods may be embodied using transistors, logic gates, and electrical circuits (e.g., application specific integrated ASIC circuitry and/or in Digital Signal; Processor DSP circuitry). For example, the WLAN module 104, the loading module 402, the match module 414 and other modules of FIGS. 1-5 may be enabled using a WLAN circuit, a loading circuit, a match circuit and other circuits using one or more of the technologies described herein.

In addition, it will be appreciated that the various operations, processes, and methods disclosed herein may be embodied in a machine-readable medium and/or a machine accessible medium compatible with a data processing system (e.g., a computer system), and may be performed in any order. Accordingly, the specification and drawings are to be regarded in an illustrative rather than a restrictive sense.

What is claimed is:

1. A method, comprising:
accessing a die identification data of a wireless local area network (WLAN) module when the WLAN module is integrated to a device having a non-volatile memory; and
writing initialization data corresponding to the die identification data to the non-volatile memory,
wherein the WLAN module is manufactured separately from the device.

2. The method of claim 1, further comprising storing the initialization data to a database file during a manufacturing process of the WLAN module.

3. The method of claim 2, wherein the initialization data to include at least vendor specific data and calibration data which render an optimal performance of the WLAN module while meeting a specification of the WLAN module.

4. The method of claim 3, wherein the vendor specific data to include at least one of a platform type, a radio type, a media access control address, a boot loader sequence, a register setting, and other data.

5. The method of claim 4, wherein the database file is stored to at least one of a server and a portable storage device including at least one of a diskette, a compact disc, a hard disk, and a flash drive.

6. The method of claim 5, wherein the die identification data embedded in a die identification register of the WLAN module is a unique value assigned to a chipset of the WLAN module.

7. The method of claim 6, wherein the non-volatile memory is of a non-volatile storage device embedded in the device.

8. The method of claim 7, further comprising detecting a presence of the initialization data through accessing the non-volatile memory.

9. The method of claim 8, further comprising automatically fetching the initialization data of the database file using a trivial file transfer protocol (TFTP) when the detecting the presence of the initialization data fails.

10. The method of claim 9, further comprising loading the initialization data to the non-volatile memory of the device using the TFTP when the initialization data corresponds to the die identification data.

11. The method of claim 1 in a form of a machine-readable medium embodying a set of instructions that, when executed by a machine, causes the machine to perform the method of claim 1.

12. A system, comprising:
a server to store initialization data of a wireless local area network (WLAN) module; and
a loading module of a data processing system to duplicate the initialization data to non-volatile memory of a device based on a die identification data of the WLAN module when the WLAN module is integrated to the device.

13. The system of claim 12, further comprising a testing device coupled to the WLAN module to obtain calibration data of the initialization data associated with the WLAN module during a manufacturing process of the WLAN module.

14. The system of claim 13, further comprising a die identification register of the WLAN module to store the die identification data of the WLAN module, wherein the die identification register is 64 bit in size.

15. The system of claim 14, wherein the initialization data to include a header which is identical to the die identification data of the WLAN module.

16. The system of claim 14, further comprising a non-volatile storage device associated with the device to store the initialization data when the die identification data of the WLAN module in the device matches with the header of the initialization data.

17. The system of claim 16, further comprising delivering the initialization data using a portable storage device, wherein the portable storage device to include at least one of a floppy disk, a compact disc, an optical disk, a hard disk, a flash drive, and other portable device.

18. An apparatus, comprising:
a loading module to write initialization data to a non-volatile memory of a device having a wireless local area network (WLAN) module when a die identification data of the WLAN module corresponds to the initialization data.

19. The apparatus of claim 18, further comprising a match module of the loading module to compare a header of the initialization data with the die identification data of the WLAN module when the WLAN module is integrated to the device.

20. The apparatus of claim 19, wherein the loading module to operate as a part of a boot sequence of the device during a manufacturing process of the device.
